(19) United States
(12) Patent Application Publication
(10) Pub. No.: US 2002/0189899 A1
(43) Pub. Date: Dec. 19, 2002

(54) Platform/access device

(76) Inventors: Robert Ian Hedley, Milbrodale via Singleton (AU); Christopher Nash Whybin, Banxton (AU)

Correspondence Address: CESARI AND MCKENNA, LLP, 88 BLACK FALCON AVENUE, BOSTON, MA, 02210, US

(21) Appl. No.: 10/210,293

(22) Filed: Aug. 1, 2002

Related U.S. Application Data
(63) Continuation of application No. 09/675,241, filed on Sep. 29, 2000.
Application No. 09/675,241 is a continuation of application No. 09/350,558, filed on Jul. 9, 1999, now abandoned.

(30) Foreign Application Priority Data
Jul. 10, 1998 (AU) PP4626/98

(51) Int. Cl. E06C 9/00

(52) U.S. Cl. 182/84; 182/127

(57) ABSTRACT

An access device having a landing and a ladder. The landing is pivotally movable about a first end thereof between a substantially vertically upright stored position and a substantially horizontally outwardly extending access position. The ladder is pivotally connected to a second end of the landing and cooperatively movable with the landing between a substantially vertically downwardly extending stored position and a substantially outwardly inclined access position.

### CROSS-REFERENCE TO RELATED APPLICATIONS

This application is a continuation of Ser. No. 09/675,241, filed Sep. 29, 2000, now abandoned, which was a continuation of Ser. No. 09/350,558, filed Sep. 9, 1999, now abandoned.

### BACKGROUND OF THE INVENTION

1. Field of the Invention

The present invention relates to an access device, and in particular, to a device which permits access to industrial machinery by providing a ladder and platform combination which may be moved between an access position, and a stored position.

2. Description of the Prior Art

Various access devices are presently known which permit easy access from a substrate surface to the cabin of an earthmoving or other industrial machine. Due to different sized and shaped vehicles and industrial equipment, different types of access devices are required to be designed for particular situations. Some such access devices are described in the Applicant's Australian Application Nos. 672706, 14992/97, 48282/97, PP1750/98 and PP1751/98.

### SUMMARY OF THE INVENTION

The present invention relates to a novel access device which is useful to firstly extend outwardly from a cabin location, over the track or tire of an earthmoving or other equipment, and then downwardly towards a substrate surface.

In one broad form, the present invention provides and access device, including:

a landing, pivotally moveable about a first end thereof between a substantially vertically upright stored position and a substantially horizontally outwardly extending access position; and,

a ladder, pivotally connected to a second end of said landing and cooperatively moveable with said landing between a substantially vertically downwardly extending stored position and a substantially outwardly inclined access position.

Preferably, said outwardly inclined access position, said ladder is angled between 55° and 75°, and most preferably about 62°, relative to a substantially horizontal substrate surface.

Also preferably, said device is pivoted by movement of a hydraulic cylinder or the like, a first end of said hydraulic cylinder being pivotally connected to a mounting post and a second end of said hydraulic cylinder being pivotally connected to said landing.

In a preferred form, said second end of said hydraulic cylinder is pivotally connected to said landing at a position intermediate said first and a second end of said landing, but most preferably, more proximal to said first end, such that, by extension of said hydraulic cylinder, said device is moved to said access position, and, by contradiction of said hydraulic cylinder, said device is moved to said stored position.

Preferably, the access device further includes a guide arm, a first end of said guide are being pivotally connected to a first end of said ladder but spaced apart from said pivotal connection to said platform, and, a second end of said guide arm being connected directly or indirectly to said first end of said landing, such that controlled movement of said ladder is effected during movement of said landing.

In a preferred form, said first end of said guide arm is connected to said mounting post at a position spaced apart from said first end of said platform.

In an alternatively preferred form, said second end of said guide arm is connected to said second end of said platform via at least one pivotally moveable guide extension means.

Preferably, said pivotally moveable guide extension means includes a longitudinal member, a first end of which is pivotally connected to said mounting post while a second end is pivotally connected to an intermediate position of a boomerang-shaped member, a first end of said boomerang-shaped member being pivotally connected to said second end of said guide arm, while a second end of said boomerang-shaped member being pivotally connected to said second end of said hydraulic cylinder.

### BRIEF DESCRIPTION OF THE DRAWINGS

The present invention will become more fully understood from the following detailed description of preferred but non-limiting embodiments thereof, described in connection with the accompanying drawings, wherein:

FIG. 1, in FIGS. 1(a) to 1 (c), shows a first embodiment of the present invention; and,

FIG. 2, in FIGS. 2(a) to 2(c), shows a second embodiment of the present invention.

### DETAILED DESCRIPTION OF PREFERRED EMBODIMENTS

Throughout the drawings, like numerals will be used to identify similar features, except where expressly otherwise indicated.

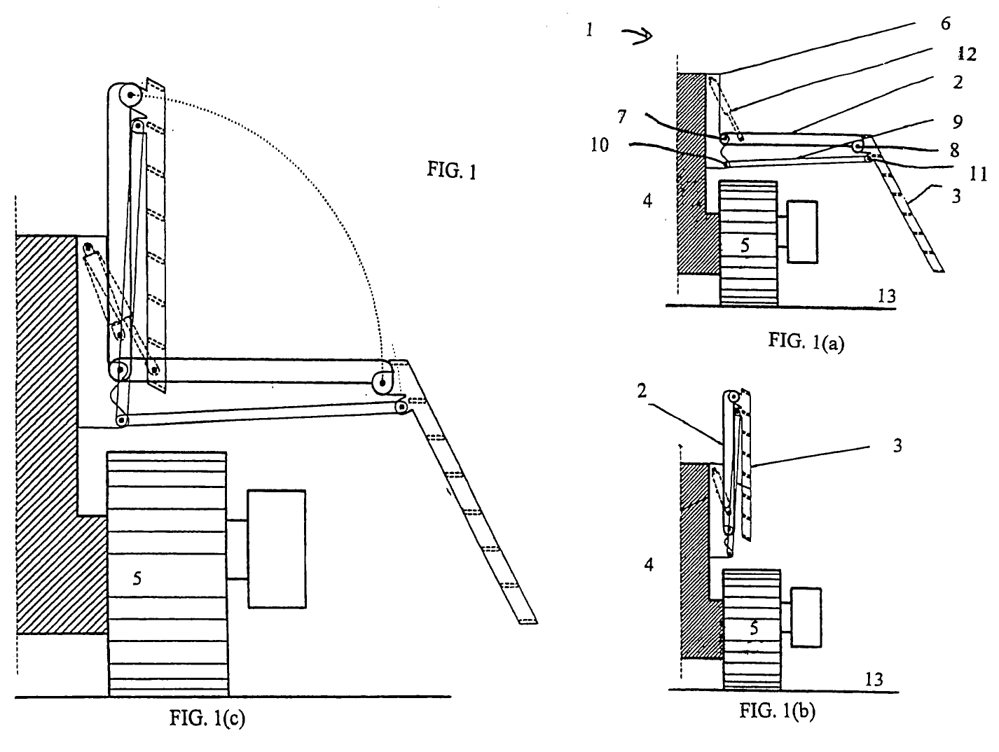

As shown in FIG. 1, the access device, generally designated by the numeral 1, comprises a landing 2 and a ladder section 3. FIG. 1(a) illustrates the access device in the access or lowered position, while FIG. 1(b) illustrates the access device in the raised or stored position. FIG. 1(c) shows the trajectory of movement between the access and stored positions.

The access device 1 is typically attached to an earthmoving or other equipment which comprises a body 4 and a tire or track 5. In the configuration shown in FIG. 1, a mounting post 6, which may form part of the body 4, or which may be attached to the body 4, supports the access device 1. The platform or landing 2 is pivotally connected at pivot point 7 to the mounting post 6. The other end of the landing 2 is pivotally connected at pivot point 8 to the ladder section 3. A guide arm 9 is additionally provided connected to mounting post 6 at pivot point 10, and to ladder section 3 at pivot point 11, such that, as the landing 2 is raised and lowered by means of an hydraulic cylinder 12 or other movement mechanism, the ladder section undergoes controlled movement to the raised or stored position shown in FIG. 1(b). Details of typical trajectories and movements of the various components are shown in FIG. 1(c), as the hydraulic cylinder is operated between its extended position showing FIG. 1(a) and is retracted position shown in FIG. 1(b).

It will be seen that the access device is therefore moved between an access position wherein the ladder preferably extends outwardly at an angle of between 55° and 75°, but perhaps most preferably, at about 62° relative to a substrate surface, and in that position, the landing is provided in a substantially horizontal disposition, allowing easy access of an operator between a substrate surface 13 and the body 4. When the access device is provided in the stored position, the platform and the ladder are both provided to a position upwardly raised such that each of the components is provided in a substantially vertical disposition close to the earthmoving equipment, such that it is totally out of the way of any earthmoving operations, which are being performed on or adjacent to the substrate surface 13.

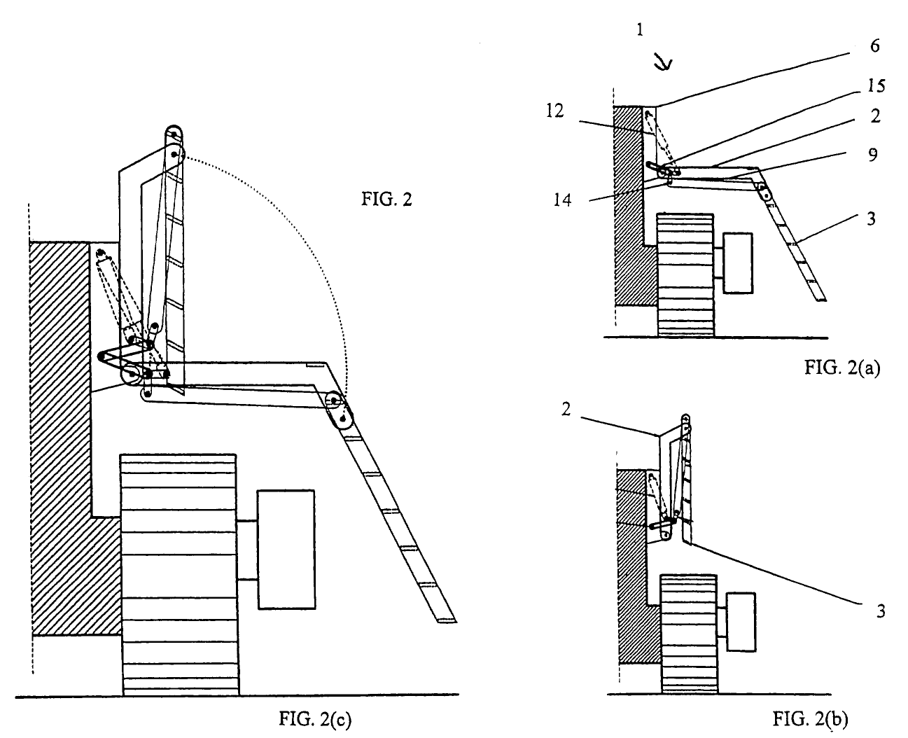

An alternative embodiment is illustrated in FIG. 2, which also provides an access device having the advantages of that of FIG. 1, i.e. the device is provided with a landing 2 and a ladder section 3 and is moveable between an access position as shown in FIG. 2(a) and a stored position shown in FIG. 2(b). Once again, the trajectory movement is illustrated in FIG. 2(c). In this embodiment, however, the pivotal connections between the ladder and the landing, and also between the landing and the mounting post 6, are varied. A ladder guide arm 9 is still provided, but is connected to one end of a boomerang arm 14, the other end thereof being connected to the hydraulic cylinder 12. The intermediate portion of the boomerang arm 14 is then connected to an additional guide arm 15 which provides the connection to the mounting post 6. As illustrated in FIG. 2(c), movement of the access device 1 is still performed in a similar manner, whereby contraction or expansion of the hydraulic cylinder 12 is effected to facilitate such movement.

It will be understood that other variations and modifications to the access device of the present invention will become apparent. All such variations and modifications should be considered to fall within the scope of the invention as broadly hereinbefore described.

What is claimed is:

1. An access device adapted to be attached to an earthmoving, mining or other large vehicle and to permit access from a substrate surface to a cabin of said vehicle over a wheel or other outwardly extending vehicular component thereof, the access device including:
a landing, moveable about a first pivot axis at a first end thereof between a substantially vertical upwards stored position and a substantially outwardly extending, substantial horizontal access position to overlie said wheel or other vehicular component;
a ladder, pivotally connected at a second pivot axis to a second end of said landing, and being moveable between a substantially vertical downwards extending stored position and a substantially outwardly declined access position;
an hydraulic cylinder, a first end of which is pivotally attached to a mounting post and a second end of which is pivotally attached to said landing, to effect movement of said landing between said stored and access positions, and
a substantially straight guide arm, not appreciably longer than said landing to effect cooperative and controlled movement of said landing and said ladder relative to one another as said device is moved between said stored position and said access position, a first end of said guide arm being attached at a third pivot axis to said ladder at a position spaced slightly below said second pivot axis and a second end of said guide arm being attached to a fourth pivot axis spaced slightly below said first pivot axis so that the entirety of the guide lies close to the landing in both positions of the landing;
such that, in said access position, said landing and guide arm extend substantially horizontally over said wheel or other vehicular component and, in said storage position, said landing and guide arm extend generally vertically in a compact manner with the entirety of said ladder being positioned above the fourth pivot axis.

2. An access device as claimed in claim 1, wherein in said access position, said ladder is angled between 55° and 75° relative to a substantially horizontal substrate surface.

3. An access device as claimed in claim 1, wherein said second end of the hydraulic cylinder is pivotally connected to said landing at a position proximal to said first end thereof, such that, by extension of the hydraulic cylinder, said device is moved to said access position, and, by contraction of said hydraulic cylinder, said device is moved to said stored position.

4. An access device as claimed in claim 1, wherein said second end of the guide arm is connected to said first end of the landing via at least one pivotally moveable guide extension means.

5. An access device as claimed in claim 4, wherein said guide extension means include a longitudinal member, a first end of which is pivotally connected to said mounting post while a second end thereof is pivotally connected to an intermediate position of a boomerang-shaped member, a first end of said boomerang-shaped member being pivotally connected to said second end of the guide arm, and a second end of said boomerang-shaped member being pivotally connected to said second end of the hydraulic cylinder.
